(19) United States
(12) Patent Application Publication
(10) Pub. No.: US 2007/0266433 A1
(43) Pub. Date: Nov. 15, 2007

(54) System and Method for Securing Information in a Virtual Computing Environment

(76) Inventor: Hezi Moore, Atlanta, GA (US)

Correspondence Address: J. Michael Martinez de Andino, Esq.;HUNTON & WILLIAMS LLP, Riverfront Plaza, East Tower, 951 E. Byrd Street, Richmond, VA, 23219-4074, US

(21) Appl. No.: 11/680,858

(22) Filed: Mar. 1, 2007

Related U.S. Application Data
(60) Provisional application No. 60/779,127, filed on Mar. 3, 2006.

(51) Int. Cl. G06F 15/16

(52) U.S. Cl. 726/15

(57) ABSTRACT

A virtual security appliance is provided for disposition in a virtual network having at least one other virtual network device, the virtual network residing on a host data processing machine. The virtual security appliance comprises an interface configured for receiving a data communication directed to the at least one other virtual network device and a security function module adapted for initiating a security function responsive to said data communication meeting predetermined criteria.

### BACKGROUND OF THE INVENTION

This application claims priority to U.S. Provisional Application No. 60/779,127 filed Mar. 3, 2006, which is incorporated herein by reference in its entirety.

The present invention relates to computer networking and network security. More particularly, the invention relates to security systems for use in a virtual machine environment.

The use of information Technology can help organizations improve employee productivity, business process automation and other functions. However, it can also increase management, operational and budgetary challenges.

As computing needs increase within an organization, additional physical computers are frequently installed to handle incremental applications and processing workloads. However, dedicating machines to specific computing applications can result in a proliferation of physical computers that creates operational, logistical and total cost of ownership (TCO) issues. This computing model may also waste capital resources, because applications typically don't fully utilize CPU, memory and other capacities on a given machine. This means organizations may purchase and maintain computing resources that are frequently under-utilized or idled.

One solution to these computing problems is server virtualization. Server virtualization uses specially-designed software to create “virtual machines” that run simultaneously on, and share the resources of, a single physical machine (a host). The virtualized environment may also include a “virtual network” or “virtual LAN” that creates a virtualized local area communications network infrastructure within the host machine.

By allowing virtual machines to share host computer resources, virtualized configurations can make more efficient use of existing computing capacity and consolidate the number of physical computers that must be purchased, installed and maintained. This can help organizations improve management, logistical and operational issues.

Network and data security are also key operational issues for organizational information technology and virtualized environments. Traditionally, organizations have deployed firewalls, intrusion prevention, anti-virus and other security technologies to protect their critical IT assets and data. At a broad level, hosts, virtual machines and networks require the same security precautions as any critical, non-virtualized, IT resource. However, the virtual environment created within a physical host computer platform presents special, incremental security challenges that are not addressed by traditional security solutions.

### SUMMARY OF THE INVENTION

In one illustrative aspect, the invention provides a virtual security appliance for disposition in a first virtual network having at least one other virtual network device, the first virtual network residing on a host data processing machine. The virtual security appliance comprises an interface configured for receiving a data communication directed to the at least one other virtual network device and a security function module adapted for initiating a security function responsive to said data communication meeting predetermined criteria.

Further objects, features and advantages of the invention will be apparent from the description below taken in conjunction with the accompanying drawings.

### BRIEF DESCRIPTION OF THE DRAWINGS

FIG. 1 is a schematic representation of a virtual network in which a virtual security appliance according to an embodiment of the invention is used to provide in-line control of data communications between two virtual machines.

FIG. 2 is a schematic representation of internal elements of a virtual security appliance that may be used in systems and methods of the invention.

FIG. 3 is a schematic representation of a virtual network in which a virtual security appliance according to an embodiment of the invention is used off-line (out-of-band) -to monitor data communications between two virtual machines.

FIG. 4 is a schematic representation of a virtual network in which a virtual security appliance according to an embodiment of the invention is used to provide in-line control of data communications between external sources and two virtual machines and between the two virtual machines.

FIG. 5 is a schematic representation of a virtual network to which a virtual security infrastructure according to an embodiment of the invention is used to provide in-line control of data communications between external sources and two virtual subnetworks and between the virtual subnetworks.

FIG. 6 is a schematic representation of a virtual network to which a virtual security infrastructure and Virtual Security Appliances according to an embodiment of the invention have been applied and in which a load-balancing device is used to allocate traffic to the Virtual Security Appliances.

FIG. 7 is a schematic representation of a virtual network to which a virtual security infrastructure and Virtual Security Appliances according to an embodiment of the invention have been applied to provide off-line (out-of-band) monitoring of data communications between external sources and two virtualized subnetworks and between the virtualized subnetworks.

FIG. 8 illustrates actions in a method of applying a virtual security infrastructure to a virtual network residing on a host machine.

### DETAILED DESCRIPTION OF THE INVENTION

Server virtualization uses software to create multiple virtual devices that run simultaneously on and share the resources of a single physical machine (host machine) and virtual networks that create a virtualized local area communications network infrastructure within the host machine. Thus, a single physical machine may contain several virtual machines communicating with one another over one or more virtual networks. Such virtual systems may give rise to the same security risks present in physically networked systems. These risks may relate to threats from, among other things, viruses, spyware, and unauthorized communications.

Where virtual systems differ is that security threats may originate, not only from other machines communicating over a physical network (external threats), but from within the host machine itself (internal threats). External threats typically involve host/virtual machine exposure to hostile content during communications with resources outside the host. Because these communications transit network resources outside the host machine, they may be configured to pass through conventional network security devices such as firewall, anti-virus or intrusion detection systems. Such devices would protect the host, and the virtual devices hosted therein, just as they would any physical machine on the network.

Internal threats, however, present a different challenge. Within a given host, the owner of and/or applications running on one virtual machine may be hostile or dangerous to owners and/or applications running on other virtual machines in the same virtual network. Failure to effectively protect virtual machines from each other can result in the spread of computer viruses, theft of data, denial of service, regulatory compliance conflicts or other consequences. Internal (i.e., intra-host) threats may come from various vectors as described in the following paragraphs.

Legitimate Intra-Host Communications: Legitimate intra-host communication pathways (such as those between virtual machines) are a potential source of exposure. These communications typically use the virtual network infrastructure and/or other channels unseen outside the host While this facilitates efficient communication between virtual machines, network security devices external to the host cannot see, and can therefore not control, these communication flows. This may result in the spread of viruses, theft of data or other issues. For example, a virtual machine infected with a computer worm may spread the worm to other virtual machines within the host when it communicates via an unprotected intra-host virtual LAN.

Unauthorized Intra-Host Communications: Unauthorized intra-host communication pathways (for example, between virtual machines) are another potential source of threats. While virtualization technology can give virtual machines a logical partition level comparable to the “air gap” separation between physical machines, this software-defined barrier can potentially be breached, for example, by a threat that penetrates the host or virtualization platform technology. This may create a potential “back door” entry point for intruders or other hostile activity.

Intra-Host Denial of Service: It may be possible for a malicious or infected virtual machine to deliberately or unwittingly inflict a denial of service attack on other local virtual machines by consuming host processing and or virtual LAN resources. For example, a virtual machine might flood the virtual LAN with malformed or high volume traffic that precludes legitimate access by other virtual machines.

IntraHost Spyware Applications: It may be possible to compromise the virtual LAN or host environment with technology that allows sensitive data to be monitored and made available to an unauthorized third party. Examples include technology that intercepts keyboard inputs, video output, unencrypted memory images, unencrypted IP communications, file transfers, etc. The term “spyware” is used herein to describe malicious software intended to intercept or take partial control of a computer's operation without the user's informed consent, typically for the benefit of a third party.

Intra-host threats such as those noted above are difficult or impossible to control with traditional security tools because they are propagated by the virtual network infrastructure and/or other channels unseen outside the host. Conventional firewalls and other security tools outside the Host cannot inspect or control the virtual network traffic. As a result, these unmonitored, unsecure intra-host communications expose virtual machines to unauthorized or undesirable communication originating from other virtual machines.

The present invention makes use of virtual security appliances to provide virtual environment security infrastructures for protecting virtual machines or devices interconnected by a virtual network on a single host machine. As used herein, the term “virtual machine” refers to a virtualized computing environment running on a host machine. A “virtual device” is a simulated representation of the functionality and interface provided by a physical network component. As used herein, the terms “host” and “host machine” refer to the data processing equipment that provides the physical environment and computing resources used to support one or more virtual machines. The term “virtual network” refers to a virtualized infrastructure running on a host machine. This infrastructure forms a virtualized networked communication environment that may include a variety of virtual devices including but not limited to virtual switches, routers, segments, network interface cards and other virtual elements. Virtual machines and networks are typically established on a host machine through the use of specialized software packages that define the rules and operating characteristics of the virtual environment. In some instances, it may also be possible to define a virtual environment via hardware.

Virtual Environment Security

In most relevant respects, operation of a virtual network and communications between virtual network devices are executed in the same manner as operation of and communications on a physical network. As noted above, however, the usual security devices cannot be used to protect the constituents of a virtual network from threats generated within the virtual network's host machine. The present invention provides the desired threat protection through the use of virtual security appliances (VSAs). VSAs are virtual devices defined under the constraints of the virtual network operating system residing on the host machine. They may be configured for interaction with the constituents of a virtual machine and, in particular, may be configured for monitoring communications between virtual network devices.

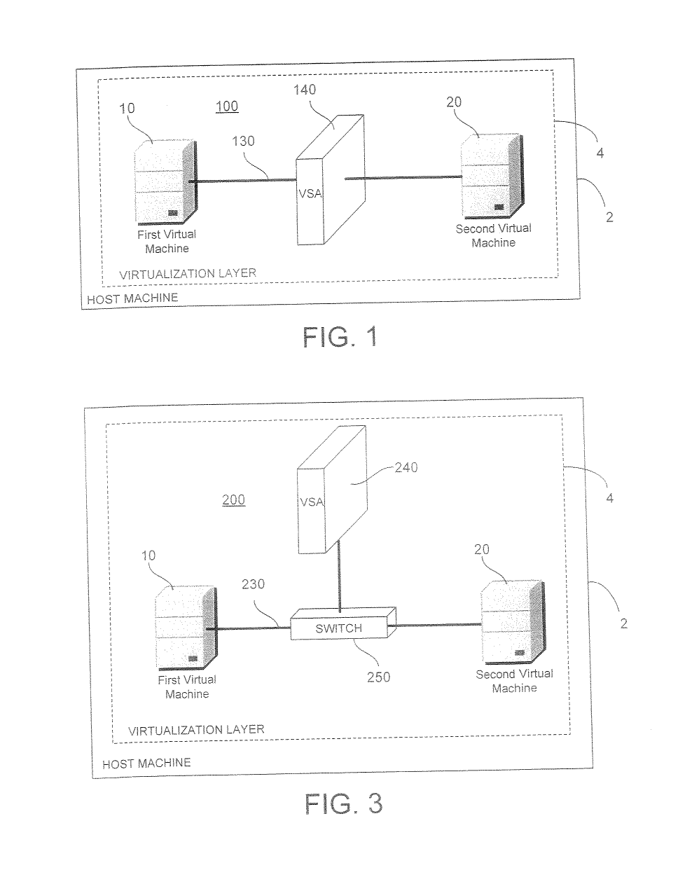

VSAs are constructed and operate in conjunction with other devices in a virtual network. FIG. 1 schematically illustrates the architecture of a VSA-protected virtual network 100 in its simplest form. The virtual network 100 resides in a virtualization layer 4 on a host machine 2. The virtualization layer 4 represents a virtual environment established by specialized software running on the host machine 2. The virtual network 100 comprises a first virtual machine 10 in communication with a second virtual machine 20 via a virtual communication channel 30. A VSA 140 is interposed between the first virtual machine 10 and the second virtual machine 20, such that any communication between the first and second virtual machines 10, 20 must pass through the VSA 140. The VSA 140 thus operates as an in-line control point with respect to communications between the first and second virtual machines 10 and 20. In this role, the VSA 140 functions as a virtualized Layer 2 network bridge. It may be programmed to intercept and inspect communication traffic and allow or deny traffic based on the presence of unauthorized or undesirable content, as defined by predetermined security rules. The VSA 140 may be programmed to execute any of the security functions that would ordinarily be carried out by an analogous non-virtual security device in a physical network. Such security functions may generally include preventing data communications from reaching the elements of the virtual network, activating a security applications (e.g., network security applications or applications for securing other applications running on the virtual network), creating an electronic record of data communications and transmitting alerts. More particularly, the VSA 140 may be programmed to perform one or more typical security functions including, but not limited to, firewall applications, intrusion detection, intrusion prevention, anti-virus applications, anti-spyware applications, denial of service mitigation, network access control, network discovery, network quarantine, identity management, network policy enforcement, and security information reporting.

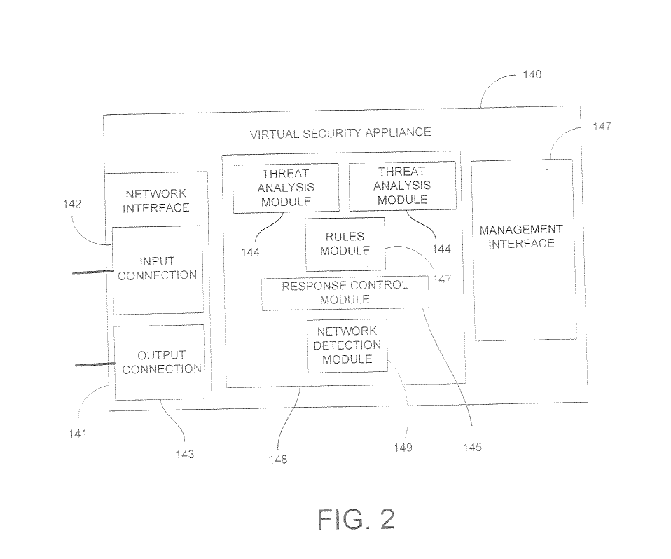

It will be understood by those of ordinary skill in the at that the VSA 140 may have programmed therein any of various rules relating to the above security functions. These rules may define attributes, thresholds, behaviors and/or other characteristics associated with unauthorized or undesirable network traffic. With reference to FIG. 2, a VSA 140 may be provided with a plurality of modules configured for carrying out these security functions. The VSA 140 may, for example be provided with an interface portion 141 having an input connection 142 configured for receiving data and an output connection 143 for transmitting data and/or sending commands. The VSA 140 may include a security function module 148 having one or more threat analysis modules 144 adapted for evaluating threats posed by received data packets. The threat module(s) 144 may be adapted to evaluate the data based on predetermined criteria including particular security rules stored in a rules module 147. A response control module 145 may be configured for carrying out or initiating any of various actions based on the output of the threat analysis module(s) 144. These may include accepting the data into the virtual network 100 or allowing the data to pass to another virtual network device such as one of the virtual machines 10, 20. Alternatively, the action may be to block or reroute the data transmission. The actions may also include initiating an alert, e-mail or other advisory message. The VSA 140 may also include a management interface 146 to allow for administration, control and monitoring of the functions of the VSA 140.

The VSA 140 may also include a network detection module 149 configured to provide a network discovery functionality to the VSA. The network detection module 149 uses passive communication monitoring to detect the various devices of the virtual network 100. It may be used to profile communication flows between network nodes and identify changes or additions to system services, state or roles.

FIG. 3 illustrates a variation on the architecture of the simple virtual network described above. Again, the virtual network 200 resides in a virtualization layer 4 on a host machine 2. In this variation, the virtual network 200 includes a first virtual machine 10 that is again in communication with a second virtual machine 20 over a virtual network communication channel 30. As before, the virtual network includes a VSA 240. In this embodiment, however, the VSA 240 is not positioned directly within the flow of traffic between the first and second virtual machines 10 and 20. Instead, the VSA 240 is positioned to operate as an out-of-band monitoring and control mechanism. In this configuration, the VSA 40 can transparently observe and inspect communication traffic by using a data collection process that operates outside normal network traffic flow. The VSA 240 may be provided with the capability to respond to observed traffic attributes by issuing alerts, recording data and/or executing other defined functions. The VSA 240 may also be configured to interact with other elements of the virtualized network environment to enforce controls. Usage of a VSA in this manner may be desirable in instances where a human alert response is desired or the effects of various security policies are being evaluated prior to automated deployment.

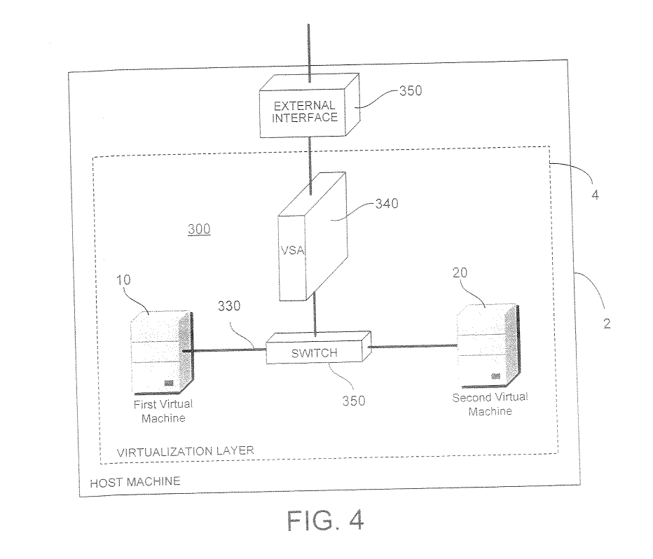

In addition to protection of network devices within a virtual network, VSAs can also be used to holistically protect the virtualization layer and the host machine itself In the virtual network 300 of FIG. 4, for example, virtual machines 10 and 20, which are in communication via virtual network communication channel 30 may be protected by VSA 340 from threats carried by communications received into the host machine (or a particular virtualization layer on the host machine) via an external interface 350. In this case, the VSA 340 acts as a controlled bridge between the virtualized network 300 and the physical systems of the host machine. As such, the VSA 340 can intercept and inspect communication traffic between virtualized and external resources and allow or deny traffic based on the presence of unauthorized or undesirable content, as defined by predetermined security rules.

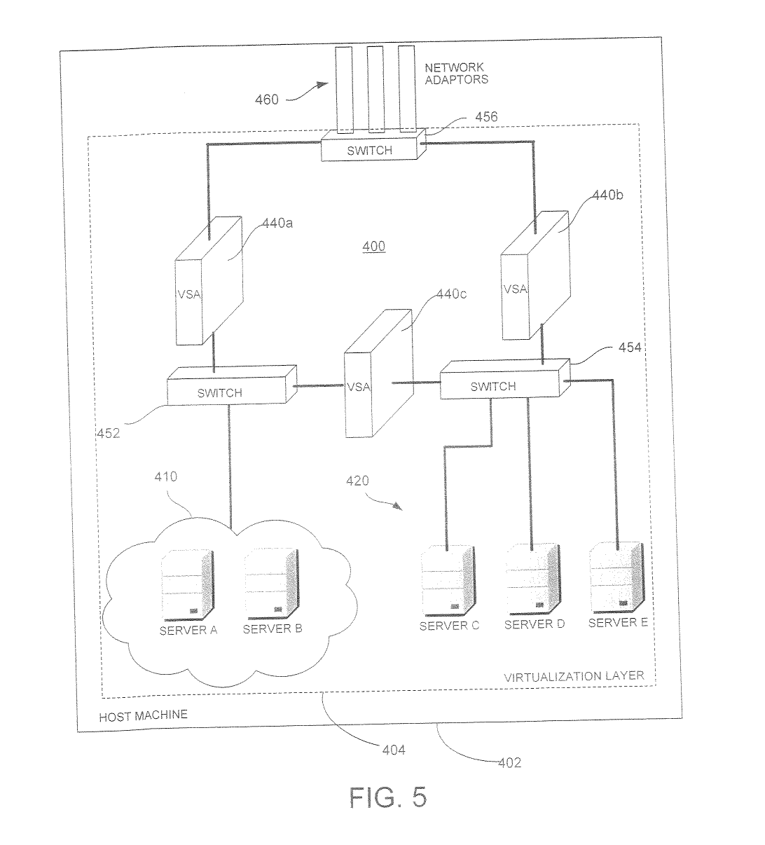

It will be understood that any number of VSAs may be deployed within a virtualized environment. Depending on requirements, a VSA could be placed in front of key virtual servers, between virtualized LAN segments and or between virtual servers and the physical world outside the host. FIGS. 5-7 schematically illustrate three examples of how VSAs may be deployed in more complex virtual network configurations. FIG. 5 illustrates a virtual network 400 established within a virtualization layer 404 on a host machine 402. The virtual network 400 has five virtual servers A, B, C, D, E interconnected by virtual network communication channels and virtual switches 452, 454. The virtual network 400 also includes a third virtual switch 456 in communication with network adaptors 460 for communication with other virtual networks. It will be understood that one or more of the network adaptors 460 may be configured for communication with devices external to the host machine. The virtualized network 400 is segmented into a first zone 410 including virtual servers A and B, which are the critical servers in the network 400 and a second zone 420 including virtual servers C, D and E, which are considered to be less critical.

The virtual network 400 also includes three VSAs 440a, 440b, 440c positioned and configured for application of-line intrusion prevention and firewall protection. A first VSA 440a is positioned between the first virtual switch 452 and the third virtual switch 456, and a second VSA 440b is positioned between the second virtual switch 454 and the third virtual switch 456. The first and second VSAs 440a, 440b may both be configured with intrusion prevention system (IPS) and firewall applications to protect the virtual network 400 from threats originating outside the virtual network 400. The third VSA 440c is positioned between the first and second switches 452, 454 so that it can control communication between the two zones 410, 420 of the network 400. The third VSA 440c may also be configured with IPS and firewall applications to assure that threats originating from the non-critical servers C, D, E are not propagated to the critical servers A, B.

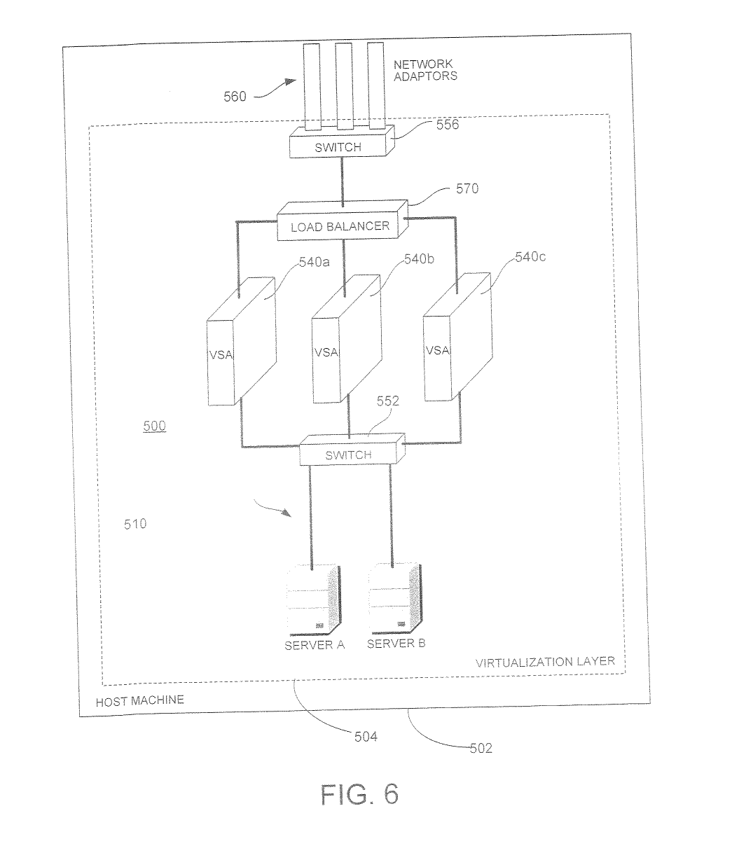

FIG. 6 illustrates how in-line VSAs may be used in a load balanced configuration to protect a virtual network 500 having a high throughput or high-availability requirements relative to traffic from other virtual networks and or physical devices/networks. In this manner, virtualized security appliances may be shared among various VLANs, IPs, networks or other virtualized network assets based on transient or persistent demand, availability and congestion conditions. As in the previous example, the virtual network 500 resides within a virtualization layer 504 on a host machine 502. The virtual network 500 and has two virtual servers A, B positioned in zone 510. The servers A, B are interconnected through a first virtual switch 552. The virtual network 500 also includes a second virtual switch 556 in communication with network adaptors 560 for communication with other virtual networks and or systems. It will be understood that one or more of the network adaptors 560 may be configured for communication with devices external to the host machine. As in the previous example, the network 500 includes three in-line VSAs 540a, 540b, 540c. In this instance, however, all three are positioned to protect the virtual network 500 from external threats. All externally originating traffic is routed through a virtualized load balancer 570, which is used to efficiently allocate traffic loads among the three VSAs 540a, 540b, 540c. Each of the three VSAs is configured with IPS and firewall applications for monitoring and controlling externally generated communications before they reach the servers A, B.

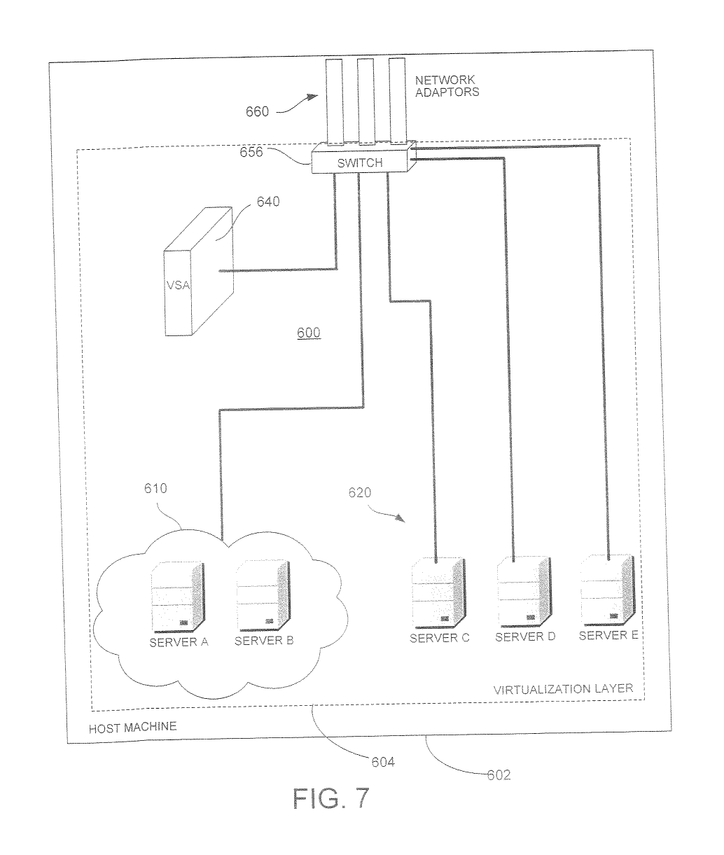

FIG. 7 illustrates the use of a VSA in an out-of-band monitoring role. FIG. 7 illustrates a virtual network 600 disposed in a virtualization layer 604 on a host machine 602 and having five servers A, B, C, D, E divided into two zones 610, 620. Again, the first zone 610 comprises two critical virtual servers A, B and the second zone 620 comprises three less critical servers C, D, E. All of the servers are connected directly to a virtual switch 656 in communication with one or more network adaptors 660. A single VSA 640 is also connected to the virtual switch 656. In this network configuration, however, the VSA 640 is not connected in-line between the switch 656 and the servers A, B, C, D, E. Instead, the VSA is positioned and configured to monitor all network traffic into and out of the virtual network 600. The VSA 640 may be configured with any appropriate monitoring application and may be programmed to generate alerts or initiate other actions in response to predetermined criteria being met. In a particular embodiment, the VSA 640 could be configured to collect data via a mirrored port on the virtual switch 656 and to relay traffic control instructions to the switch 656 or other devices via 802.1x or comparable protocols.

The VSAs of the invention may be configured to use deep packet inspection, content analysis, event aggregation, and other methods to provide any of various network security functions. As noted above, these security functions may include firewalls, intrusion detection, intrusion prevention, anti-virus applications, anti-spyware applications, denial of service mitigation, network access control, network discovery, network quarantine, identity management, network policy enforcement, and security information reporting. Rules for each of these security functions may be programmed into the VSAs. Such rules define the attributes, thresholds, behaviors and/or other characteristics associated with unauthorized or undesirable network traffic.

The VSAs of the invention may be configured so that the processing tasks associated with the above-described security functions are carried out through the use of the host machine's CPU resources. VSA security applications (firewall, IDS, IPS, etc), however, can potentially consume significant CPU resources. If the host's core CPU resources are limited, the VSAs of the invention may be configured to offload inspection and analysis tasks to a special, dedicated processor or hardware acceleration card. In a particular embodiment, the VSAs may redirect such tasks to an ASIC-based processor card installed within the host machine chassis. This avoids consuming the limited resources of the host's core CPU resources, which in turn avoids degradation of the performance of other virtual devices and applications on the host. By allowing a specialized, secondary processor to handle security processing, the VSA is able to deliver security applications without unreasonably affecting or degrading the performance of other elements in the virtualized environment.

The VSAs of the invention may be provided with the capability to passively discover assets (such as virtual network devices or servers) within the virtualized environment and to profile attributes related to their configurations, active services, roles, communication flows and other dimensions. The VSA may be further provided with the capability to exercise predetermined actions based on the discovered information. Such actions may include issuing alerts, quarantining virtualized assets and other actions appropriate to a determination that a virtualized asset has or is violating behavior rules or other policies.

The above-described network discovery capabilities provide incremental and essential visualization abilities. This is highly significant because virtualized computing environments do not provide an opportunity to physically observe a network's configuration and communication flows. The VSA's network discovery tools accurately detect and present the relationships between virtual devices and allow administrators to ensure these elements are properly and legitimately configured.

VSAs according to some embodiments of the invention may include a mechanism that connects to an administrative interface (also referred to as a “management console”) for purposes of security application management, reporting, system configuration, update distribution and other tasks. The management console has the capability to provide aggregated, correlated and interpreted information related to security events that occurred within the virtualized or related environments. The management console may be configured with the capability to create and distribute real-time and historical security event reports in text, graphical and interactive formats; monitor, control and administer a variety of network security services deployed on the VSA (such as Firewall, IPS, Anti Virus, etc. ); monitor, control and administer select third-party network devices in the virtualized or related network environments; and or support centralized policy definition and deploy instructions (such as policy changes or updated threat profiles) to one or more VSAs or third-party network devices. The management console and related functions may be deployed on a virtual server or an external physical appliance.

The methods and software devices of the invention may be tailored for deployment in a particular virtualization platform. This is significant because the various vendor's virtualization platforms use different rules, processes, terminology, and device definition. Example virtualization platforms include VMware ESX Server, Microsoft Virtual Server 2005 R2], XenSource XenEnterprise, and Virtual Iron Software Virtual Iron.

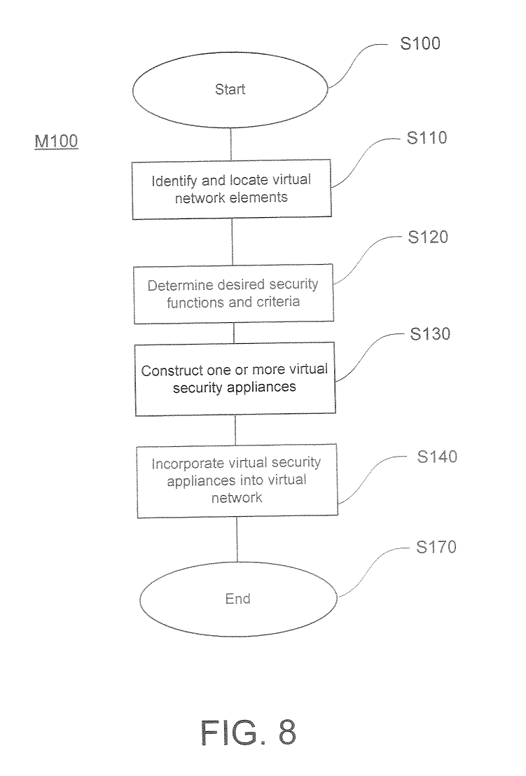

The virtual security systems of the invention may thus be incorporated into any virtual network environment. FIG. 8 illustrates a method M100 of applying a virtual security infrastructure to a virtual network residing on a host machine. The method begins at S100. At S110, the architecture and constituent elements of the virtual network are determined. This may be accomplished manually or automatically using the above-described network discovery utility. At S120, the desired security functions and criteria are determined. This will generally be a function of the virtual network architecture, the degree of interconnectivity of the virtual network with other virtual networks and with data sources external to the host machine, and the applications running on the virtual network.

At S130, one or more VSAs are constructed based on the above-determined security functions and criteria. These VSAs may be programmed with any of the characteristics and security functions described herein. Each VSA may be configured as an in-line controller or an out-of-band monitor as described above. At S140, the VSAs are installed in the virtual network. The VSAs are specifically tailored to the requirements of the software used to create and operate the virtual network. As such, each VSA meets the connectivity requirements necessary for the VSA to interact with, control and monitor the virtual devices of the network. The method ends at S150.

It will be understood that the virtual security infrastructures of the invention may be applied to an existing virtual network or may be integrated into a virtual network during initial network construction.

In an exemplary application of a security infrastructure according to an embodiment of the invention, VSAs patterned after physical security devices were tailored to and incorporated into virtual networks established using the VMware ESX Server. ESX Server provides a virtual software infrastructure for partitioning, consolidating and managing servers. As a typical virtualization system, ESX Server allows the creation of multiple virtual machines running on a single host machine.

In this application, VSAs were configured so that they (1) replicate the operational attributes and interfaces of a physical network security appliance, (2) support the desired hardened Linux OS and security software applications, and (3) meet the device requirements of the ESX Server operating system.

It will be understood that from the perspective of the security/sensor software, VSAs may be substantially similar to physical devices. They differ in that physical security devices make use of discrete, dedicated physical components (CPU, memory, storage media, network interface cards, etc.) while VSAs make use of host machine resources to replicate the functions of such physical components. Once the virtual components are established, however, it is generally possible to implement security software programs that are identical or slightly modified versions of the security software programs used in physical security devices.

Thus, in the exemplary VMware-based system, the VSAs were provided with a sensor platform that is a modified, minimalistic version of the 3.0 Debian GNU/Linux distribution with a patched version of the 2.4.32 Linux kernel. This is a representative intrusion detection and prevention platform used in comparable physical security devices.

In order to establish compatibility with ESX Server virtual devices, certain modifications to the security device software were made. First, because the build process of the physical security device simulated by VSA assumes flash chips that use the IDE interface, SCSI support was added to the operating system kernel and virtualization platform. Next, a VMDK (virtual disk) was created that is the same size as the physical flash chips used in the physical system and the contents of the physical flash chip were transferred to the virtual disk in such a way that the contents of the physical and virtualized storage devices were identical. This method simulates the functionality of the flash memory chips used in the physical security device and allows the VSA to function from the virtualized disk.

In the exemplary system, the intrusion detection and prevention functionality requires the use of promiscuous mode on all non-management interfaces. Accordingly, the appropriate virtualized network interface cards and related virtualized network elements were configured to provide promiscuous mode support. In the exemplary VMware virtualized environment, this is accomplished by setting the system configuration option “PromiscuousAllowed” (under /proc/vmware/net) to “Yes” on all appropriate VMware virtual network interface cards (“vmnics”) and VMware virtual networks (“vmnets”).

In the exemplary VMware-based environment, the management interface needed by the sensor is relatively low-traffic. Thus, the management interface used by VMware was changed so as to be shared between the VMware console and the virtual machines. (In the VMware environment, this is executed via the “vmkpcidivy” utility). This allows avoiding the necessity of reserving a NIC solely for sensor management.

As an example use, the above-described system was deployed in a VMware ESX Server virtualized environment that contained two subnetworks (subnets). Subnet A included two virtual servers and subnet B included three virtual servers. The physical host computer platform was a Dell PowerEdge server with a dual core 2.0 GHz Intel Xeon processor, 16 Gb RAM, running VMware ESX Server 3.0.

100 Mbps network traffic from a physical data center entered the physical host platform and proceeded to a virtualized 100 Mbps LAN that was created within the VMware virtualized environment. Once on the virtualized LAN, 100 mbps traffic passed through a virtual switch (created via the VMware ESX Server virtualization environment) that directed traffic to the two subnets. A VSA instance and an additional virtual switch were deployed between the virtual switch and each subnet. A third VSA was deployed between the two intermediate virtual switches.

This data center configuration provided intrusion prevention for traffic between the two subnetworks and resources outside the host platform. Most unique, it also provided intrusion protection that protected traffic transiting on the virtualized LAN segments and in between the virtualized Subnet A and Subnet B.

This usage description is intended solely to demonstrate a working deployment and does not represent or imply the maximum performance or configuration capabilities of the virtual security systems of the invention.

General Implementation

General aspects of possible implementation of the inventive technology will now be described. Various method and operating system embodiments of the inventive technology are described above It will be appreciated that the systems of the invention or portions of the systems of the invention may be (or be implemented on) a “processing machine” such as a general purpose computer, for example. As used herein, the term “processing machine” is to be understood to include at least one processor that uses at least one memory. The at least one memory stores a set of instructions. The instructions may be either permanently or temporarily stored in the memory or memories of the processing machine The processor executes the instructions that are stored in the memory or memories in order to process data. The set of instructions may include various instructions that perform a particular task or tasks, such as those tasks described above in the flowcharts. Such a set of instructions for performing a particular task may be characterized as a program, software program, or simply software.

As noted above, the processing machine executes the instructions that are stored in the memory or memories to process data This processing of data may be in response to commands by a user or users of the processing machine, in response to previous processing, in response to a request by another processing machine and/or any other input, for example,

As previously discussed, the processing machine used to implement the invention may be a general purpose computer. However, the processing machine described above may also utilize any of a wide variety of other technologies including a special purpose computer, a computer system including a microcomputer, mini-computer or mainframe for example, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a program able logic device such as a FPGA, PLD, PLA or PAL, or any other device or arrangement of devices that is capable of implementing the steps of the process of the invention.

It will be understood that in order to practice the methods of the invention as described above, it is not necessary that the processors and or the memories of the processing machine be physically located in the same geographical place. That is, each of the processors and the memories used in the invention may be located in geographically distinct locations and connected so as to communicate in any suitable manner. Additionally, It will be understood that each of the processor and/or the memory may be composed of different physical pieces of equipment. Accordingly, it is not necessary that a processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing as described above is performed by various components and various memories. It will be understood, however, that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, a telecommunications network (e.g., a cellular or wireless network) or any client server system that provides communication, for example. Such communications technologies may use any suitable protocol such as TCP/IP, UDP, or OSI, for example.

As described above, a set of instructions is used in the processing of the invention, The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

It will be understood that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, C#, COBOL, dBase, Forth, Fortran, Java, Modula-2, Pascal, Prolog, REXX, Visual Basic, and/or JavaScript, for example. Further, it is not necessary that a single type of instructions or single programming language be utilized in conjunction with the operation of the system and method of the invention. Rather, any number of different programming languages may be utilized as is necessary or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a magnetic stripe, a laser card, a smart card, a processor chip, a memory chip, a DVD, an integrated circuit, a hard disk, a floppy disk, an optical disk, a flash memory card, a magnetic tape, a RAM, a ROM, a PROM, a EPROM, a wire, a cable, a fiber, communications channel, a satellite transmissions or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, telephone (landline, cellular or wireless), voice reader, voice recognizer, dialogue screen, menu box, list, checkbox, toggle switch, a pushbutton or any other device that allows a user to receive information regarding the operation of the processing machine as it processes a set of instructions and/or provide the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

While the foregoing illustrates and describes exemplary embodiments of this invention, it is to be understood that the invention is not limited to the construction disclosed herein. The invention can be embodied in other specific forms without departing from the spirit or essential attributes.

What is claimed is:

1. A virtual security appliance for disposition in a first virtual network having at least one other virtual network device, the first virtual network residing on a host data processing machine, the virtual security appliance comprising:
an interface configured for receiving a data communication directed to the at least one other virtual network device; and
a security function module adapted for initiating a security function responsive to said data communication meeting predetermined criteria.

2. A virtual security appliance according to claim 1 wherein the security function comprises an action selected from the set consisting of preventing the data communication from reaching the at least one other virtual network device, activating a security application, creating an electronic record of the data communication and transmitting an alert.

3. A virtual security appliance according to claim 2 wherein the security application is one of the set consisting of a network security application and an application for securing another application running on the first virtual network.

4. A virtual security appliance according to claim 2 wherein the security application is one of the set consisting of an anti-virus application, an anti-spyware application, and a process for mitigating service denial.

5. A virtual security appliance according to claim 1 wherein the predetermined criteria includes a set of security rules for use in conjunction with the security function, at least a portion of the security rules being stored in a data storage module in the virtual security appliance.

6. A virtual security appliance according to claim 1 wherein the data communication is originated by a first virtual network device within the first virtual network and is directed to a second virtual network device within the first virtual network.

7. A virtual security appliance according to claim 1 wherein the data communication is originated by a source external to the first virtual network.

8. A virtual security appliance according to claim 7 wherein the data communication is originated by a second virtual network on the host data processing machine.

9. A virtual security appliance according to claim 7 wherein the data communication is originated by a source external to the host data processing machine.

10. A virtual security appliance according to claim 1 wherein the interface is configured for out-of-band monitoring of the data communication.

11. A virtual security appliance according to claim 10 wherein the security function includes an action selected from the set consisting of collecting data communication data and transmitting an alert.

12. A virtual security appliance according to claim 1 wherein the virtual security appliance is configured to instruct a processing resource other than a core CPU of the host data processing machine to carry out at least a portion of the security function.

13. A virtual security appliance according to claim 1 wherein the virtual network resides in a virtual environment established by a virtual software platform running on the host data processing machine and the virtual security appliance is tailored for compatibility with the virtual environment.

14. A virtual security appliance according to claim 1 further comprising:
a network detection module configured for detecting constituent devices of the first virtual network.

15. A method of securing a first virtual network, the method comprising:
identifying at least one virtual device in the first virtual network; and
incorporating a virtual security appliance into the first virtual network, the virtual security appliance being configured for receiving a data communication directed to the at least one virtual network device and initiating a security function responsive to said data communication meeting predetermined criteria.

16. A method according to claim 15 wherein the security function comprises an action selected from the set consisting of preventing the data communication from reaching the at least one other virtual network device, activating a security application, creating an electronic record of the data communication and transmitting an alert.

17. A method according to claim 16 wherein the security application is one of the set consisting of a network security application and an application for securing another application running on the first virtual network.

18. A method according to claim 16 wherein the security application is one of the set consisting of an anti-virus application, an anti-spyware application, and a process for mitigating service denial.

19. A method according to claim 15 further comprising:
determining a set of security rules for use in conjunction with the security function; and
storing at least a portion of the security rules in a data storage module of the virtual security appliance.

20. A method according to claim 15 wherein the data communication is originated by a first virtual network device within the first virtual network and is directed to a second virtual network device within the first virtual network.

21. A method according to claim 15 wherein the data communication is originated by a source external to the first virtual network.

22. A method according to claim 15 wherein the data communication is originated by one of the set consisting of a second virtual network on the host data processing machine and a source external to the host data processing machine.

23. A method according to claim 15 wherein the virtual network resides in a virtual environment established by a virtual software platform running on the host data processing machine, the method further comprising:
tailoring the virtual security appliance for compatibility with the virtual environment.

24. A computer program embodied in a computer-readable medium, the computer program comprising instructions for performing a set of actions comprising:
incorporating a virtual security appliance into a first virtual network residing on a host data processing machine, the first virtual network including at least one other virtual network device, the virtual security appliance being configured for receiving a data communication directed to the at least one other virtual network device and initiating a security function responsive to said data communication meeting predetermined criteria.

25. A computer program according to claim 24 wherein the set of actions further comprises:
identifying the at least one virtual device in the first virtual network.

26. A computer program according to claim 24 wherein the security function comprises an action selected from the set consisting of preventing the data communication from reaching the at least one other virtual network device, activating a security application, creating an electronic record of the data communication and transmitting an alert.

27. A computer program according to claim 26 wherein the security application is one of the set consisting of a network security application and an application for securing another application running on the first virtual network.

28. A computer program according to claim 26 wherein the security application is one of the set consisting of an anti-virus application, an anti-spyware application, and a process for mitigating service denial.

29. A computer program according to claim 24 wherein the data communication is originated by a first virtual network device within the first virtual network and is directed to a second virtual network device within the first virtual network.

30. A computer program according to claim 24 wherein the data communication is originated by a source external to the first virtual network.

31. A computer program according to claim 24 wherein the data communication is originated by one of the set consisting of a second virtual network on the host data processing machine and a source external to the host data processing machine.

32. A computer program according to claim 24 wherein the virtual network resides in a virtual environment established by a virtual software platform running on the host data processing machine and the virtual security appliance is capable of being tailored for compatibility with the virtual environment.

33. A virtual security system for protecting a virtual network device in a virtual network on a host data processor from threats carried by data communications from at least one data communication source external to the virtual network, the virtual security system comprising:
at least one virtual security appliance in communication with the virtual network device, each of the at least one virtual security appliance being configured for receiving, via a network interface, data communications from the at least one data communication source and for initiating a security function responsive to one of said data communications meeting predetermined criteria.

34. A virtual security system according to claim 33 wherein the security function comprises an action selected from the set consisting of preventing the data communication from reaching the at least one other virtual network device, activating a security application, creating an electronic record of the data communication and transmitting an alert.

35. A virtual security system according to claim 34 wherein the security application is one of the set consisting of a network security application and an application for securing another application running on the first virtual network.

36. A virtual security system according to claim 34 wherein the security application is one of the set consisting of an anti-virus application, an anti-spyware application, and a process for mitigating service denial.

37. A virtual security system according to claim 33 wherein the predetermined criteria includes a set of security rules for use in conjunction with the security function, at least a portion of the security rules being stored in a data storage module in the virtual security appliance.

38. A virtual security system according to claim 33 wherein the at least one data communication source comprises one of the set consisting of a virtual network device and a physical data communication source.

39. A virtual security system according to claim 33 further comprising:
a virtual load balancer disposed intermediate the network interface and the at least one security appliance, the virtual load balancer being configured for receiving the data communications and, for each data communication, selecting one of the at least one virtual security appliance and directing the data communication to the selected virtual security appliance.

40. A virtual security system according to claim 39 wherein the virtual load balancer is configured to select the virtual security appliance based on predetermined criteria relating to at least one of the set consisting of communications traffic level and virtual security appliance capacity.

41. A virtual security system according to claim 33 wherein the network interface comprises a plurality of virtual network devices each having a corresponding one of the at least one virtual security appliance disposed in-line intermediate the network interface and the virtual network device.
